(19) United States
(12) Patent Application Publication
(10) Pub. No.: US 2026/0310713 A1
(43) Pub. Date: Oct. 8, 2026

(54) AUTOMATIC DIGITAL MODEL SECURITY CLASSIFICATION USING ARTIFICIAL INTELLIGENCE

(71) Applicant: The Aerospace Corporation, El Segundo, CA (US)

(72) Inventors: Richard O. DAY, Alexandria, VA (US); Daeshik KIM, Sterling, VA (US); Gregory S. MOWLES, Springfield, VA (US); Julie S. FANT, Haymarket, VA (US); David DIGIORGIO, Warrenton, VA (US)

(73) Assignee: The Aerospace Corporation, El Segundo, CA (US)

(21) Appl. No.: 19/169,700

(22) Filed: Apr. 3, 2025

(51) Int. Cl. G06F 16/353; G06F 3/0484; G06F 9/445; G06F 21/57

(52) U.S. Cl. CPC G06F 16/353; G06F 16/45; G06F 16/55

(57) ABSTRACT

Automatic security classification using AI using AI for security classification of text and digital descriptive models that provide technology-assisted derivative classification capabilities is disclosed. The automated security classification system applies security classification markings to model-based system engineering (MBSE) or descriptive models. Such a system can accurately predict the security classification of the plain text and graphical notation of a descriptive model.

### STATEMENT OF GOVERNMENT INTEREST

This invention was made with government support under Contract No. FA8802-19-C-0001 awarded by the Department of the Air Force. The government has certain rights in the invention.

### FIELD

The present invention generally relates to artificial intelligence (AI), and more specifically, to automatic security classification using AI for security classification of text and digital descriptive models.

### BACKGROUND

Beginning in the 1950s, a series of Executive Orders established what is known today as the United States Government Classification System (GCS). This system employs layered security classification guides that provide instructions and rules for humans to “mark” or “tag” certain information to safeguard the information from unauthorized disclosures, which is vital to achieving national security goals. The GCS was a springboard for creating a body of documents with security markings that is still growing rapidly today.

The process of placing security classification markings on documents requires a security subject matter expert (SSME) to read each relevant security classification guide (SCG) and then mark information manually while attempting to keep in mind tens to hundreds of rules about what is to be protected. This practice is time consuming and suffers from numerous human errors. These issues are compounded by the fact that 35% of the security classification guides (SCGs) are out of compliance.

To further aggravate this situation, the adoption of digital engineering (DE) is replacing acquisition and engineering documentation with complex descriptive models that contain highly enriched information using graphical notation to convey a new meaning that is not readily decipherable in English. To classify these descriptive models, SSMEs must first step through and portion mark the property text of each model element, and second, place a security marking at the top of a model view by recursively interpreting the meaning of all the viewable node-to-node relationships. The complexity of the second step is beyond the capabilities of most humans. Accordingly, an improved and/or alternative approach to security classification may be beneficial.

### SUMMARY

Certain embodiments of the present invention may provide alternatives or solutions to the problems and needs in the art that have not yet been fully identified, appreciated, or solved by current security classification technologies and techniques and/or provide a useful alternative thereto. For example, some embodiments of the present invention pertain to automatic security classification using AI for security classification of text and digital descriptive models.

In an embodiment, one or more non-transitory computer-readable media store one or more computer programs. The one or more computer programs are configured to cause at least one processor to extract text from a descriptive model and generate natural language text from graphical elements of the descriptive model. The one or more computer programs are also configured to cause the at least one processor to provide the extracted and generated text to an AI model that has been trained and fine-tuned to take the extracted and generated text as input and automatically provide one or more security classification predictions for the descriptive model as output. The one or more computer programs are further configured to cause the at least one processor to process the extracted and generated text, via the AI model, receive the one or more security classification predictions as output, and generate a report including the one or more security classification predictions.

In another embodiment, a computer-implemented method includes extracting text from a descriptive model and generating natural language text from graphical elements of the descriptive model, by a computing system. The computer-implemented method also includes providing the extracted and generated text, by the computing system, to an AI model that has been trained and fine-tuned to take the extracted and generated text as input and automatically provide one or more security classification predictions for the descriptive model as output. The computer-implemented method further includes processing the extracted and generated text, via the AI model, and receiving the one or more security classification predictions as output, by the computing system. Additionally, the computer-implemented method includes generating a report including the one or more security classification predictions, by the computing system. The one or more security classification predictions include security marking predictions on at least one of an entire model project for the descriptive model, one or more model views and/or diagrams of the descriptive model, one or more selected model graphical relationships between model elements, and one or more selected descriptive model elements.

In yet another embodiment, one or more computing systems include memory storing computer program instructions and at least one processor configured to execute the computer program instructions. The computer program instructions are configured to cause the at least one processor to extract text from a descriptive model and generate natural language text from graphical elements of the descriptive model. The computer program instructions are also configured to cause the at least one processor to provide the extracted and generated text to an AI model that has been trained and fine-tuned to take the extracted and generated text as input and automatically provide one or more security classification predictions for the descriptive model as output. The computer program instructions are further configured to cause the at least one processor to process the extracted and generated text, via the AI model, receive the one or more security classification predictions as output, and generate a report including the one or more security classification predictions. The generated report also includes the text sent to the AI model. The report is accessible via a centralized reporting web application for review.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating a security classification system configured to perform automated security classification of text and digital descriptive models using AI, according to an embodiment of the present invention.

FIG. 2 illustrates a JavaScript Object Notation (JSON) data structure used between a modeling tool plugin and a REST API, according to an embodiment of the present invention.

FIGS. 3A-C are architectural diagrams illustrating a modeling tool plugin software architecture, according to an embodiment of the present invention.

FIG. 4 illustrates an interface of a modeling tool plugin settings graphical user interface (GUI), according to an embodiment of the present invention.

FIG. 5 is a flow diagram illustrating a Unified Architecture Framework Modeling Language (UAFML) unmodeling process, according to an embodiment of the present invention.

FIG. 6 is an architectural diagram illustrating a centralized reporting web application, according to an embodiment of the present invention.

FIG. 7 illustrates an example authoritative source of truth (ASOT) document repository structure, according to an embodiment of the present invention.

FIG. 8 is an architectural diagram illustrating a data operations manager (DOM) system, according to an embodiment of the present invention.

FIG. 9 illustrates data and natural language processing (NLP) pipeline functions, according to an embodiment of the present invention.

FIG. 10 is an architectural diagram illustrating a computing system configured to facilitate automated security classification of text and digital descriptive models using AI, according to an embodiment of the present invention.

FIG. 11A illustrates an example of a neural network that has been trained to assist with automated security classification of text and digital descriptive models, according to an embodiment of the present invention.

FIG. 11B illustrates an example of a neuron, according to an embodiment of the present invention.

FIG. 12 is an architectural diagram illustrating a reference architecture for a generative AI model, according to an embodiment of the present invention.

FIG. 13 is a flowchart illustrating a process for training AI/machine learning (ML) model(s), according to an embodiment of the present invention.

FIG. 14 is a flowchart illustrating a process for performing automated security classification, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to automatic security classification using AI for security classification of text and digital descriptive models. Such embodiments may provide technology-assisted derivative classification capabilities that can address the impacts of DE and the exponentially rising wave of derivative classification activity across the government. Such embodiments also have the capability to mark new material generated by descriptive modeling, safeguard classified data to the right level of protection, as well as meet new congressional requests and organizational policies with expiring security marking waivers. Humans are not reasonably able to understand and process the massive amounts of information in classification guidelines, which are constantly changing and can contain gigabytes, terabytes, petabytes, etc. of information. Also, security specialists are typically not savvy in understanding and reading descriptive, or digital, models. Also, good modelers may not understand security guides and are not necessarily experts in what they are trying to classify. This makes human classification particularly prone to error, which can be harmful to national security interests.

The automated security classification system of some embodiments applies security classification markings to model-based system engineering (MBSE) or descriptive models. Such a system can accurately predict the security classification of the plain text and graphical notation of a descriptive model. As descriptive models begin to replace classified documents, communities face an urgent need to protect the model information against unauthorized disclosure. The solution methodology of some embodiments included: (1) development of a modeling tool plugin that can extract the text from the model and generate text from the graphical notation; (2) selection of the best natural language processor for tuning and testing as the predictor; and (3) development of a distributed system where multiple modeling tools can use the plugin simultaneously to meet future scalability requirements.

Some embodiments provide MBSE modelers with the capability to classify their entire descriptive model. The classifier system in certain embodiments includes a modeling tool plugin that allows modelers to invoke the automated classification of a model. Within the modeling tool plugin, rules allow for the generation of natural language descriptions from the underlying descriptive modeling so-called “graphics.” A centralized reporting web application in some embodiments facilitates human-in-the-loop review of predicted classifications. An automated data operations pipeline can be used to develop training data from quality security marked documents. Also, an NLP operations pipeline automates the tune-testing (i.e., fine tuning) of NLP models from the training data produced by the data operations pipeline. A boundary Representational State Transfer (REST) Application Program Interface (API) waits for incoming text from the modeling tool.

The concept of operations is that modelers use the modeling tool plugin to exercise security marking predictions on the entire model project, model views/diagrams, or selected model elements. Once a modeler invokes the modeling tool plugin prediction capability on a selected and locked model project, the modeling tool plugin sends the appropriate text and English sentence (or another language, if desired) representing the modeling language graphics notation to the security marking predictor. The security marking predictor returns the security markings to the modeling tool plugin for placement back in front of the text of the MBSE descriptive model, generating a report. The report generated accounts for the text sent to a security marking predictor and predicted markings for that text. This report is stored in a database accessible by the centralized reporting web application for review.

Various technical effects, benefits, and advantages may be achieved in some embodiments. The speed of classification marking may be significantly increased and human review time may be significantly reduced. Also, human errors may be reduced or eliminated. Furthermore, gigabytes, terabytes, petabytes, or more, of data may be processed that would not be possible by human-implemented processes, whether mental or by hand.

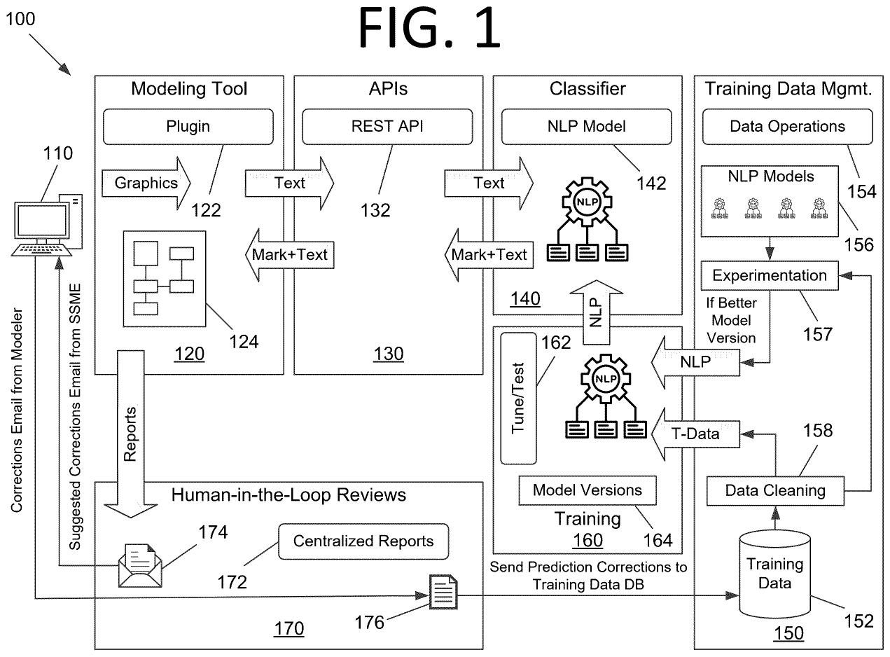

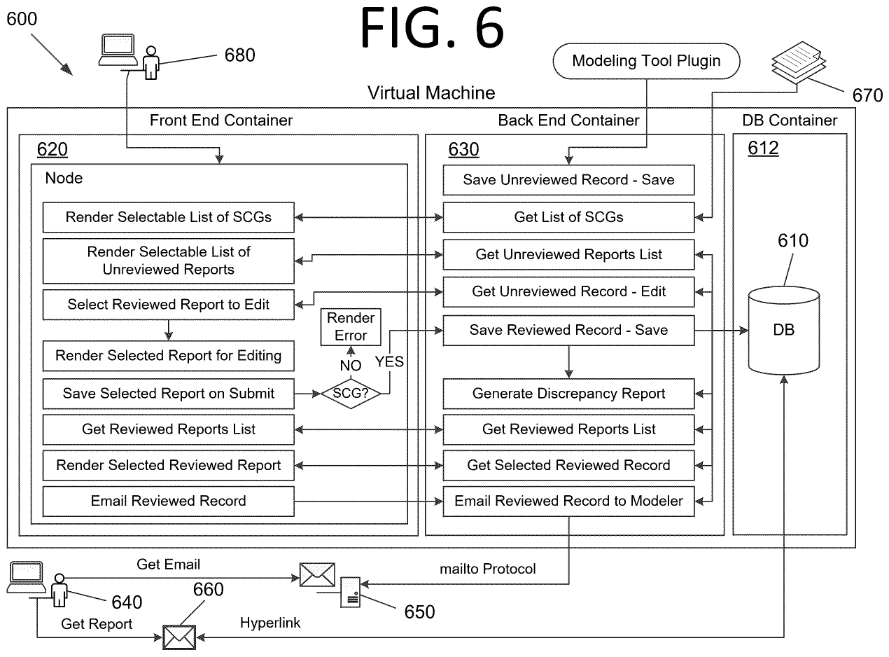

FIG. 1 is an architectural diagram illustrating a security classification system 100 configured to perform automated security classification of text and digital descriptive models using AI, according to an embodiment of the present invention. The subsystems of security classification system 100 work together to provide a modeler 110 with the comprehensive, accurate, repeatable, and scalable capability to automatically mark security classifications on descriptive models. Classification predictions may be reviewed by a security specialist. See SSME 680 of FIG. 6, for example.

A modeling tool client 120 includes a modeling tool plugin 122 that invokes the process to apply security classification portion markings to model element property text and model views. Modeling tool plugin 122 is an add-on to a modeling tool client 124 that may be implemented in Jython, for example, and may be displayed as a button on a toolbar of modeling tool client 124. In some embodiments, modeling tool plugin 122 only performs these functions on elements of the model that have been “locked” by the user, which both informs modeling tool plugin 122 of the scope of the model to process and enables modeling tool plugin 122 to have the access privileges to make changes to the model to add the portion and banner markings.

Modeling tool plugin 122 is compatible with descriptive models written in UAFML in some embodiments. Descriptive models should be stored on a model management server (not shown) for modeling tool plugin 122 to work correctly in some embodiments. The model management server may mark each model element with a unique identifier and lock models through modeling tool client 124 for editing. This eliminates a race condition, which is an issue that arises when multiple users may want to edit the same descriptive model at the same time, resulting in crashes, errors reading and writing data, security vulnerabilities, or other conflicts.

Modeling tool plugin 122 has two external interfaces in some embodiments: a REST API 132 of APIs 130 and a central reporting web application 172 of human-in-the-loop review functionality 170. Text is sent to REST API 132 using a suitable data structure, such as a JSON data structure. REST API 132 provides this text to an NLP model 142 of classifier 140.

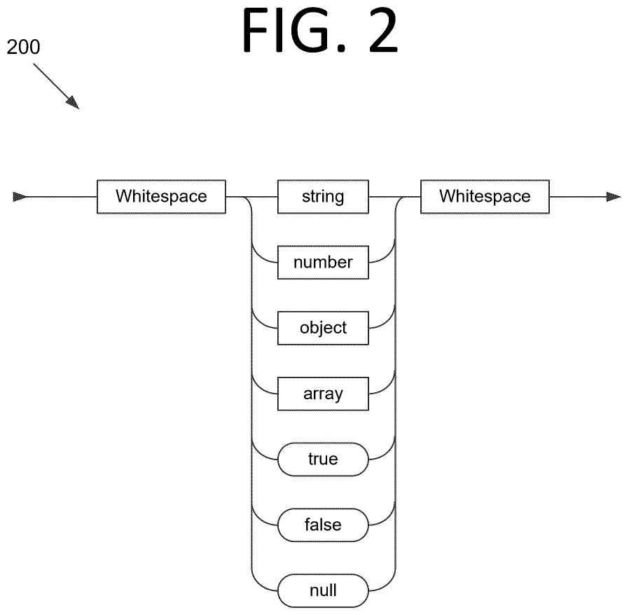

FIG. 2 illustrates a JSON data structure 200 used between modeling tool plugin 122 and REST API 132, according to an embodiment of the present invention.

An example of code for JSON data structure 200 is provided below.

```
[
  {
    “parent”: “742fbbd4-ceb7-4d2f-baa8-ddealbe92cd6”,
    “editable”: true,
    “TEXT”: “”,
    “type”: “Actual Environment ”,
```

| | |
|---|---|
| “element_class”: | “<type |

‘com.nomagic.uml2.ext.magicdraw.classes.mdkernel.impl.InstanceSpecificationImpl’>
”,

| | |
|---|---|
| “URL”: | “mdel://bfe303f6-77a6-4ec9-a5a9- |

```
215e407e4ceb?projectID=twcloud%3A%2F26abf6f1-6048-4157-801b-
5586632b0f62%2F4afb5863-622b-4d0d-9634-
6cee818a05ff&serverType=esiserver&projectBranch=trunk&serverName=twc%3A35
79&projectName=UAFML+Unmodeling_6_16_2024&elementName=Actual+Enviro
nment++Pacific+Ocean&metaType=InstanceSpecification&elementQName=Actual+
Env%2C+Actual+Condition%2C+Action+Location%3A%3APacific+Ocean”,
    “NAME”: “Pacific Ocean”,
    “TEXT_TAG”: “”,
    “relation”: {
      “slot”: [
        {
          “owner”: {
            “parent”: “742fbbd4-ceb7-4d2f-baa8-ddealbe92cd6”,
            “editable”: true,
            “TEXT”: “”,
            “type”: “Actual Environment ”,
            “NAME”: “Pacific Ocean”,
            “guid”: “bfe303f6-77a6-4ec9-a5a9-215e407e4ceb”
          },
          “type”: “Slot”,
          “defining_feature”: {
            “parent”: “a6e10cbc-ea9a-463a-bb08-04fc58653299”,
            “editable”: false,
            “TEXT”; “”,
            “type”: “Environment Property”,
            “NAME”: “Depth”,
            “guid”: “7c62aea0-5543-4918-90a0-01942430e110”
          },
          “value”: [
            “13,000ft”
          ]
        }
      ],
      “element_type”: [
        {
          “parent”: “742fbbd4-ceb7-4d2f-baa8-ddealbe92cd6”,
          “editable”: false,
          “TEXT”: “”,
          “type”: “Environment”,
          “NAME”: “Ocean”,
          “guid”: “a6e10cbc-ea9a-463a-bb08-04fc58653299”
        }
      ],
      “conforms_to”: [ ]
    },
    “children”: [
      {
        “type”: “Slot”,
        “guid”: “81862487-9afd-441d-974c-d478f07f8c88”
      }
    ],
    ‘guid”: “bfe303f6-77a6-4ec9-a5a9-215e407e4ceb”
  },
  {
    “parent”: “742fbbd4-ceb7-4d2f-baa8-ddealbe92cd6”,
    “editable”: true,
    “TEXT”: “”,
    “type”: “Actual Environment ”,
```

| | |
|---|---|
| “element_class”: | “<type |

‘com.nomagic.uml2.ext.magicdraw.classes.mdkernel.impl.InstanceSpecificationImpl’>
”,

| | |
|---|---|
| “URL”: | “mdel://a342b55c-db16-4fb6-8849- |

```
b06f5a4fd7c2?projectID=twcloud%3A%2F26abf6f1-6048-4157-801b-
5586632b0f62%2F4afb5863-622b-4d0d-9634-
6cee818a05ff&serverType=esiserver&projectBranch=trunk&serverName=twc%3A35
79&projectName=UAFML+Unmodeling_6_16_2024&elementName=Actual+Enviro
nment++Atlantic+Ocean&metaType=InstanceSpecification&elementQName=Actual+
Env%2C+Actual+Condition%2C+Action+Location%3A%3AAtlantic+Ocean”,
    “NAME”: “Atlantic Ocean”,
    “TEXT_TAG”: “”,
    “relation”: {
      “slot”: [ ],
      “element_type”: [
        {
          “parent”: “742fbbd4-ceb7-4d2f-baa8-ddealbe92cd6”,
          “editable”: false,
          “TEXT”: “”,
          “type”: “Environment”,
          “NAME”: “Ocean”,
          “guid”: “a6e10cbc-ea9a-463a-bb08-04fc58653299”
        }
      ],
      “conforms_to”: [ ]
    },
    “children”: [ ],
    “guid”: “a342b55c-db16-4fb6-8849-b06f5a4fd7c2”
  }
]
```

Prediction reports 172 are also sent to a centralized reporting web application 170 using a comma-separated values (CSV) file structure or some other organized file structure. These can be viewed by a security specialist via a web browser on his or her computing system. Additionally or alternatively, an email may be sent to the security specialist. Through these interfaces, modeling tool plugin 122 handles the bulk of the processing involved in sending reports on the classifications that have been predicted and applied.

If the security specialist wishes to make recommended corrections to the classification predictions (i.e., the security markings), these may be sent via an email 174 from an SSME to modeler 110 or submitted via centralized web application 170. Prediction corrections 176 are made by modeler 110 and then sent to a training data database 152 (e.g., stored in the form of training documents folders). Training data management functionality 150 may be provided via a data operations manager 154, which can monitor folders, employ extractors and cleaners (that perform data cleaning 158), provide measurements, and provide data storage. NLP model training 160 is performing using training data 152 and includes tuning and testing 162.

Experimentation 157 in training data management functionality 150 provides a way to find better NLP models than standard off-the-self NLP models 156 in some embodiments, such as Complement Naïve Bayes or Multinominal Naïve Bayes NLPs. Once desired the NLP model is selected, experimentation 157 may not be performed in this loop in some embodiments once the selected NLP is put into operation. However, experimentation 157 should continue as new NLPs are developed to evolve the system in the event that a better performing NLP can be discovered or developed. “Model versions” 164 in NLP model training 160 is a function to store NLP models that have been used over time. These NLP models have gone through tune/test block 162 of training 160 and after use in the NLP classifier 140.

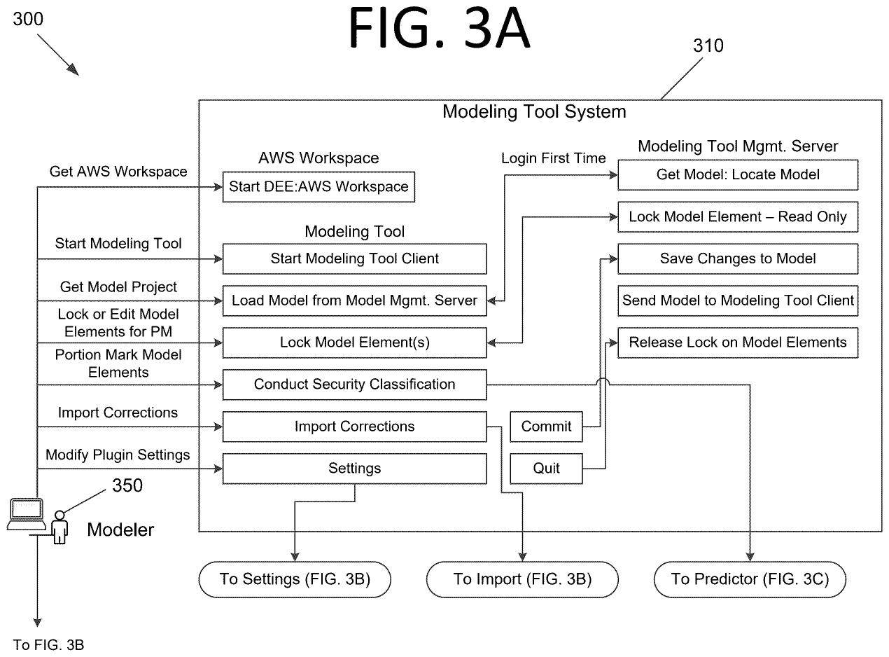

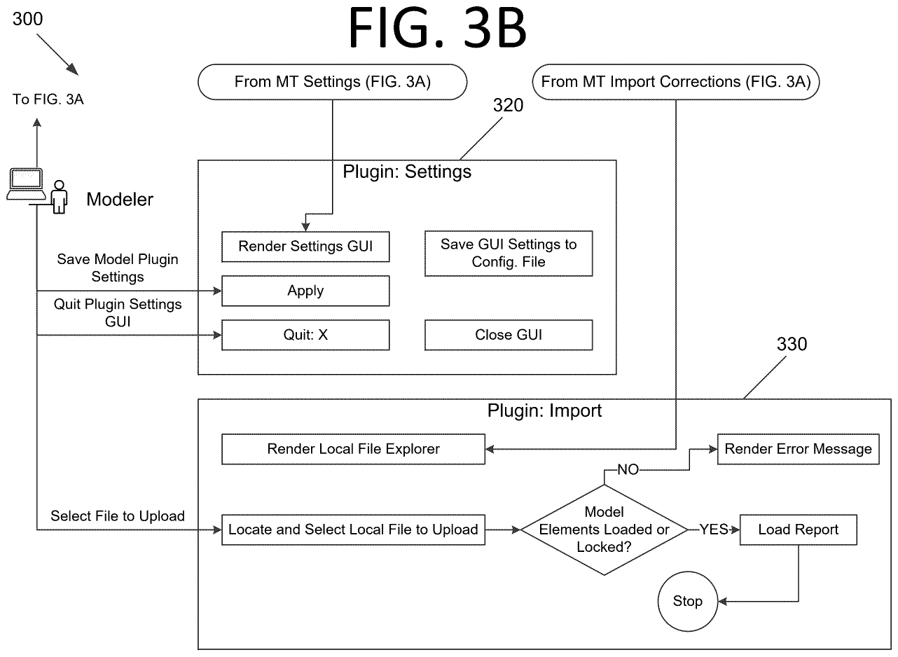

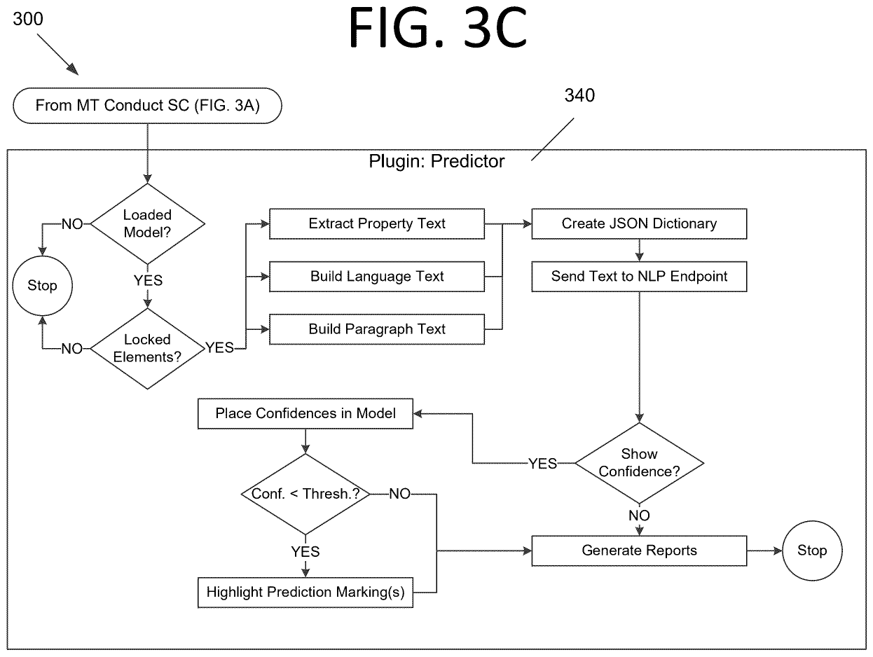

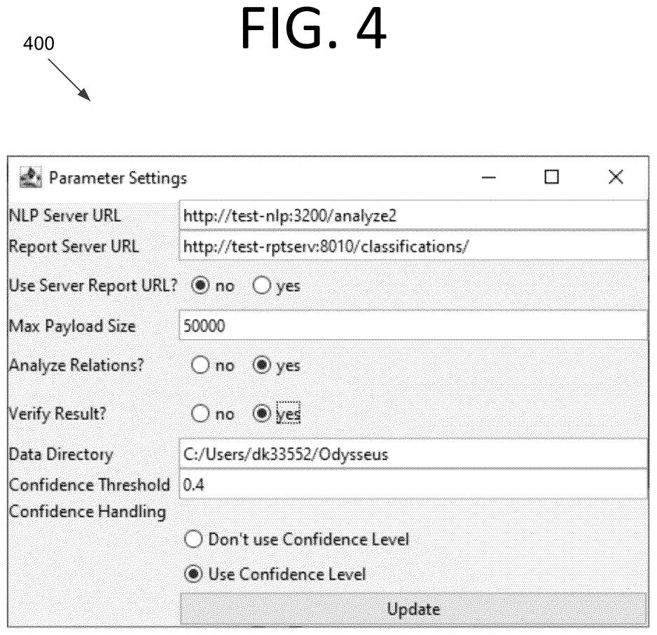

FIGS. 3A-C illustrate a software architecture 300 for such a modeling tool plugin. The modeling tool plugin (e.g., modeling tool plugin 122) interacts with a modeling tool system 310 and is made up of three components in this embodiment: a settings GUI 320, an import utility 330, and a security marking predictor 340.

Settings GUI 320 provides easy access to the configuration settings for operating security marking predictor 340 to assist testers and provide operational users, such as modeler 350, with access to the range of prediction capabilities. See interface 400 of a modeling tool plugin settings GUI, for example. Interface 400 allows users to provide an NLP server Universal Resource Locator (URL) and a report server URL. NLP server URL is the address of a unique resource with the port to access the REST API where the NLP model is located. The reports server URL is the address of the location and port to the centralized reporting web application. Users can also toggle a user server report URL radio button, which causes a report to be generated and stored in the database using the centralized reporting web application when “yes” is selected and causes a report to be generated in a CSV file and saved to the local machine files when “no” is selected. The file location is identified in the data directory text field and two files are generated: a full report and a discrepancy report.

A max payload size value (Integer) controls the maximum payload size in bytes used in REST API communication to the NLP endpoint. The confidence threshold (Float, 0-to-1) represents the lowest confidence value allowed before the security markings are highlighted in red, for example, to draw attention to the potential for an error in the predicted marking. Analyze relations radio buttons turn off the UAFML relationship to English sentence-building capability for security marking predictions for a model view when “no” is selected and turn on the UAFML relationship to English sentence-building for security marking predictions for a model view when “yes” is selected. Verify results radio buttons cause security classification markings to be placed directly in the descriptive model regardless of whether the new prediction is different from what is found in the model when “no” is selected and cause predicted security classification markings that are different than what is already in place, unless blank, to be placed into a discrepancy report only when “yes” is selected. The data directory identifies where any log files or reports are generated. The confidence handling radio buttons hide the returning confidence level value associated with the prediction security classification when “don't display confidence level” is selected and display the confidence level value with the associated predicted security classification when “use confidence level” is selected.

Users may make changes to the parameters to customize security markings predictor capabilities. Setting up the centralized reporting web application and the NLP server is important for getting the prediction and human-in-the-loop reviews to work in an integrated and automated manner. To save changes to the settings for interface 400, the user clicks the “Update” button at the bottom of interface 400. Once this button is clicked, the settings will be saved to a file and saved to a directory location in the user's profile to allow for persistence in setting choices (e.g., the user's home directory, such as “[home drive letter]: \users\ [user-name] \”).

Turning to FIG. 3C, security markings predictor 340 has five distinct functions that cover model view(s) and model element(s) property security markings in this embodiment. These are as follows.
(1) Text Module: This function pulls out raw text from each “locked” model element. The following are the fields included in the text extraction in some embodiments: text within the model element's namespace field, text within the model element's comment/documentation field, and text within editable properties (e.g., part properties).
(2) UAFML Graphics to English Module: This function builds an English sentence (or a sentence in another desired language) for each “locked” relationship or model element block with relationships. For each “locked” model element relationship, the plugin systematically matches a “rule” that has been meticulously built to assist with generating a sentence that is a textual analogue of the UAFML graphical notation between two blocks by inserting action or connecting words between the text found within each block. The sentences generated are then passed to the same prediction engine for a recommended security marking. More specifically, the security prediction operations may be as follows in some embodiments.

Create JSON Dictionaries: For locked model elements and locked model view(s), blocks, relations, and aggregate relations are collected. A JSON data array dictionary of all model elements is created in random access memory (RAM). Also, a JSON data array dictionary of all model views is created in RAM.

Extract Text for Security Marking Predictions: For each node, parent, and child in the dictionary of model elements, the name, comments, and editable properties are extracted. With extracted Text, a JSON data array of request items is built in RAM with each item having a max payload. For each data array item in the dictionary JSON data array, request items are added to 1 . . . n (request queue) of size max payload and relationships with related properties are added to the relations queue.

Send Text to NLP Endpoint using REST API: The request queue is emptied by sending 1 . . . n items to the REST API. Each request generates a response, and those 1 . . . n responses are placed in a response queue. The response queue is processed by placing prediction security markings into the model elements in front of the associated text. A sentence is created for each item in the relations queue and each sentence is placed into the request queue. The request queue is emptied by sending 1 . . . n items to the REST API.

A paragraph of sentences is created for each model view and 1 . . . j paragraphs each of size max payload are placed into the request queue. The request queue is emptied by sending 1 . . . j items to the REST API. The highest security marking level is rolled up for each 1 . . . j model view using model element text, sentences, and paragraphs on each model view.
(3) Rollup Module: This function captures the highest classification within each model element name and property of a model view to ensure the highest classification appears at the top of the model view.
(4) Reports Module: This function provides either locally generated reports or reports sent to the centralized reporting web application for human-in-the-loop review. The two types of reports that are generated in some embodiments are a full report of all text and predictions and a discrepancy report. The latter report lists items with a different security marking prediction than previously found in the model view. Table 1 below shows the format of the reports that are generated by the modeling tool plugin in some embodiments.

TABLE 1
EXAMPLE MODELING TOOL PLUGIN REPORT

| | | Classifi- | |
|---|---|---|---|
| ID: | Type: | cation: | Text: |
| _19_0_4_95e01ee_163874 . . . | NAME | (U) | (U)(19%)Basic |
| | | | Time |
| _19_0_4_95e01ee_163874 . . . | TEXT | (U) | (U)(32%)Block 1 |
| _19_0_4_95e01ee_163874 . . . | NAME | (U) | (U)(31%)Block 1 |
| _19_0_4_95e01ee_163874 . . . | NAME | (U) | (U)(9%)Basic |
| | | | Magnetic |
| | | | Field Strength |
| . . . | . . . | . . . | . . . |

(5) Compatibility Module: This function detects the version of the modeling tool and UAFML profile used during execution. Based on the version usage, the correct API code and/or proper properties are used for each version.

Turning to FIG. 3B, import utility 330 allows modeler 350 to apply the corrections reported by the quality check performed by a human-in-the-loop review. An email generated by the centralized reporting web application may have hyperlinks to the corrections report for viewing or download. Once modeler 350 downloads the discrepancy report, he or she can import the changes into the model. The file format should match the format automatically generated by the report server. Import utility 330 provides the rollup and compatibility functions discussed above.

### UAFML Graphics to English

Automatically translating UAFML graphics into English language sentences (or those of another language), also called “unmodeling,” is nontrivial. Unmodeling allows MBSE elements to be represented in a format that preserves context between different parts of a model. To accomplish this, a process is employed that converts UAFML graphics into meaningful text. The process results in a family of descriptive UAFML models and numerous code snippets (e.g., in Python), which can be tested, validated, and integrated into the modeling tool plugin.

### UAFML Unmodeling Process

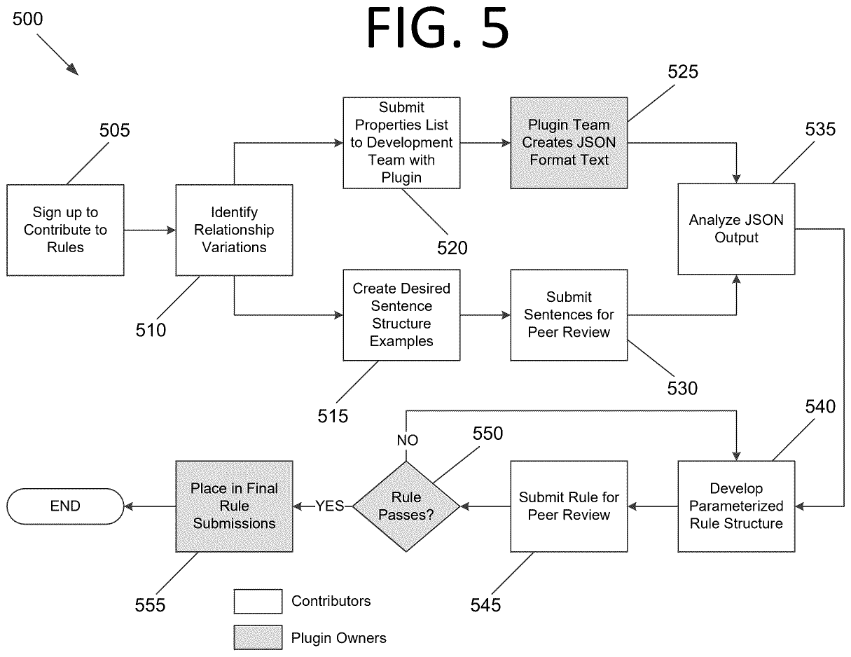

FIG. 5 is a flow diagram illustrating a UAFML unmodeling process 500, according to an embodiment of the present invention. The purpose of UAFML unmodeling process 500 is to create a set of rules that will automatically generate sentence structure of UAFML model elements, model element relationships, and model their properties. First, a modeler signs up to be responsible for a relationship or model element (e.g., a UAFML graphic) at 505 to start the process. Next, the modeler identifies and models each variation that the UAFML graphic can represent at 510. The modeler the creates sentence structure examples to define the UAFML graphic in English at 515. Using those sentences and the modeling tool, the modeler selects the appropriate properties needed within the UAFML graphics to develop the sentence and the variations with required properties are sent in parallel to a modeling tool plugin team at 520 to have a JSON file generated with the requisite information included. The plugin team does so at 525. The sentences submitted for peer review at 530 and an analysis of the JSON file is performed at 535.

A parameterized rule is created with filler words to generate the target sentence structure using the model element property text found in the variables of the JSON file at 540. This step is where the identified filler words allow for translation from UAFML graphics to text. The rule is then submitted for peer review and compared to the usage in a UAFML Domain Metamodel (DMM) specification document at 545. If approved at 550, a graphic to text rule code snippet (e.g., in Python) is integrated into the sentence creation module within the plugin at 555. If the rule fails at 550, the process returns to step 540 for further iteration.

The unmodeling process of FIG. 5 may require access to a modeling tool client and model management server. To create the JSON files from step 525, a modeler may load a model project from the model management server so the file structure has the requisite embedded unique identifiers. The modeler should know the UAFML DMM specification document and modeling tool client to build the exhaustive set of variations of the UAFML graphics a model element or relationship can have from step 510.

The unmodeling process in some embodiments generates charts (e.g., in Microsoft PowerPoint®) to capture the description of model element/relationship variations and targeted sentence structures. The JSON files generated from the plugin from step 515 result in relatively small (e.g., less than 1 kilobyte (kB)) text files. In some embodiments, no reports or logs are generated with the UAFML graphics to text rules software or process.

### Centralized Web Reporting Application

SSMEs can review and correct predicted security classifications in some embodiments, since the final source of truth should come from a human-in-the-loop. An example centralized reporting web application 600 is shown in FIG. 6. In some embodiments, centralized reporting web application may be centralized reporting web application 170 of FIG. 1. A database 610 records each report generated by the modeling tool plugin. An SSME 680 can use the functionality of the node of front end container 620 to review the reports in database 610 via back end container 630. In this embodiment, database 610 resides in database container 612. These reports can be accessed for review through centralized reporting web application 600. SSME 680 can correct predicted security classification markings by relabeling them with appropriate markings. Corrections are tied to a security classification guide by SSME 680, correcting by selecting the source for the correction when submitting a reviewed report. Security classification guides are also stored within database 610 for use by centralized reporting web application 600.

The reports generated by the modeling tool plugin contain the unique identifier of the model element where the text is located, the text, the original security classification marking, and the predicted security classification marking. These reports are placed directly into database 610. When SSME 680 is using centralized reporting web application 600, the discrepancies between predicted and original security classification markings are highlighted to bring them to the attention of SSME 680. Modeling tool reports placed into database 600 can be in two states: unreviewed and reviewed. Once a report is reviewed, SSME 680 can go back to those reports for viewing and to access the email modeler function.

Centralized reporting web application 600 has two software modules in this embodiment that work together to service the users' interface needs, provide access to the NLP training data, and provide the modeling tool reports. These two software modules are front end container 620 and back end container 630. Front end container 620 provides the graphical web interface the user sees when reviewing reports. This may be written in typescript/React, for example. Back end container 630, which interfaces with database 610 storing the training data and reports and SCGs 670, may be written in Python, for example. Together, front end container 620 and back end container 630 create centralized reporting web application, which allows the SSME to review security prediction reports. Centralized reporting web application 600 enables human reviews of prediction reports, which are placed in database 610 by the modeling tool plugin. Once corrections are identified and SSME 680 submits a reviewed report, centralized reporting web application automatically stores the corrections into the NLP training data set and flags that report as reviewed. Front end container 620 and back end container 630 may be docker containers running on a Linux® operating system, for example.

Centralized reporting web application allows SSMEs, such as SSME 680, to email modelers with corrections found in the security marking predictions. This allows SSME 680 to automatically notify a modeler 640 with references back to a reviewed report that modelers can download to their desktop for the purposes of directly importing corrections. There are two paths to trigger a security marking corrections email to modeler 640 in this embodiment. The first is when SSME 680 completes his or her review by clicking the “submit” button. At that point, SSME 680 is given the option to email modeler 640 with any corrections via a mail server 650. The second path to notify modeler 640 is available on a “view reviewed reports” tab, where once a report is brought up for review, SSME 680 will find a button for emailing modeler 640, much in the same way as the first path. The email function may be implemented using JavaScript and the mailto protocol, for example, which automatically opens the user's default email client and auto-populates the email with the email address of modeler 640 and the links to the report data. Modeler 640 then manually sets the email classification and sends an email 660.

### Training Document Folders or NLP Training Data ASOT

The NLP classifier (e.g., classifier 140 of FIG. 1) is trained using already portion-marked text from a variety of data sources. These documents should provide examples of text with all possible security markings. The NLP classifier should be continuously updated regarding new classifications of new information. The model thus cannot remain stagnant. Rather, the selected commercial off the shelf NLP model of NLP models 156 of FIG. 1 should train on new data at regular intervals. To do this, a central repository should be maintained to hold a large collection of current, properly security-marked documents from which the NLP classifier can draw on training data and continue to fine-tune its parameters. The repository should also have the current collection of all relevant SCGs for use by the system. This repository thus includes the ASOT for constructing the NLP classifier.

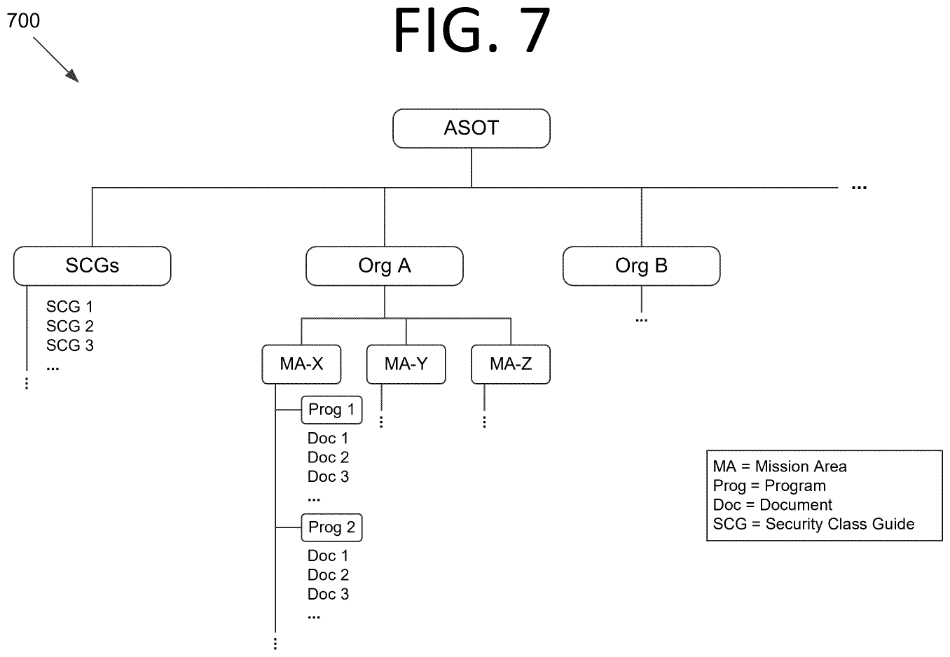

As the ASOT is a large repository of classified documents, it should reside exclusively on a classified network, as well as be properly access controlled to ensure that the classified data remains secure. In addition, the system should make certain assumptions about the structure of the ASOT. For example, it may be assumed that the repository has a hierarchical structure with organization directories at the top level, followed by mission area directories at the next level down, and specific program directories below that. There are two reasons for this assumption. First, it provides a mechanism to identify sets of data more easily with classification considerations based on proximity of purpose and function. Thus, mission area X security concerns and markings may differ considerably from those for mission area Y. Second, this assumption provides a reasonable way to isolate and more easily manage the documents that currently make up the ASOT by appropriate staff. FIG. 7 illustrates an example ASOT document repository structure 700. Another assumption is that a current and complete set of SCGs are maintained in a single directory at the top level called “SCGs”. This assumption was made to simplify the data operations software, but this does not need to be the case in all embodiments.

### Data Operations

As mentioned previously, the NLP classifier should be trained on new data at regular intervals, with that data coming from the document repository ASOT. The data operations function (e.g., data operations 150 of FIG. 1) is responsible for interacting with the ASOT and making that updated training data available for NLP training when needed. Specifically, data operations are automated through the DOM suite of software tools, which scans the data repository for changes, extracts paragraphs and their security markings from new or updated documents, and writes this information to a database (e.g., database 152 of FIG. 1) as an NLP training set along with some state data and metadata. The DOM can also monitor the SCGs and make the list of SCG names available to the centralized reporting web application.

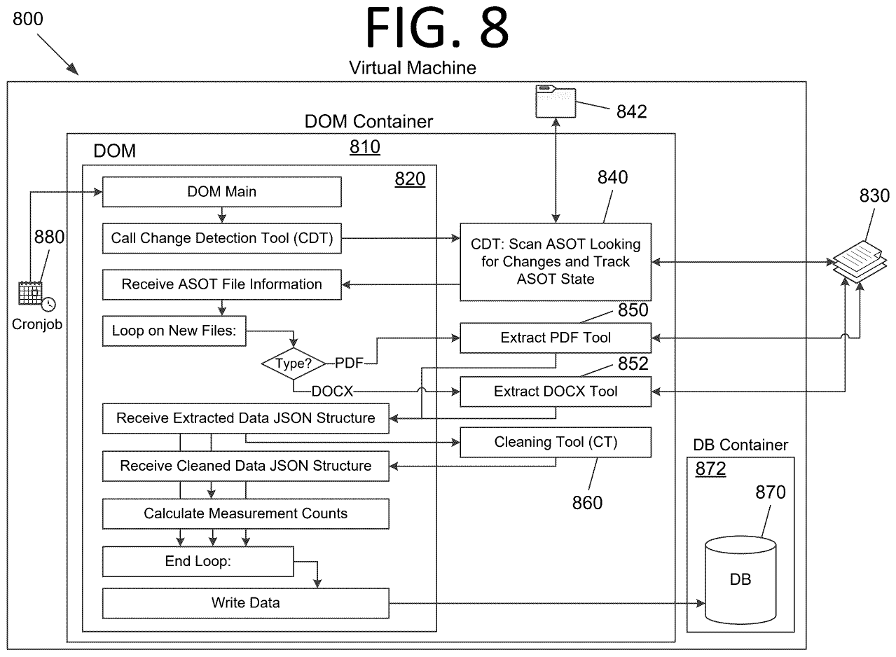

FIG. 8 is an architectural diagram illustrating a data operations manager (DOM) system 800, according to an embodiment of the present invention. DOM system 800 includes a DOM container 810 and a DOM 820 (e.g., DOM 154 of FIG. 1). DOM 820 coordinates a collection of tools and functions that monitor changes in a document repository ASOT 830.

To do so, DOM 820 executes a series of actions. DOM 820 calls a change detection tool (CDT) 840 to scan through ASOT 830 looking for changes based on ASOT state information that CDT 840 maintains in DOM log files 842. In this embodiment, CDT 840 monitors the entire hierarchy of the folders for DOM log files 842. This is performed to identify when files or folders are added, deleted, renamed, modified, or otherwise changed, typically by utilizing system-level auditing features to track these alterations and generate alerts or logs about the changes.

If CDT 840 detects a change, various actions may be taken. If a new file is detected, CDT 840 creates a unique fingerprint (e.g., by using the SHA512 algorithm on the file contents) for that file and passes the fingerprint and file path back to DOM 820. It should be noted that a new version of an existing document will look like a new file to CDT 840. If a previously encountered file is not found where expected, CDT 840 passes this information back to DOM 820 for updating the database. The new information, either new file found (along with fingerprint and path) or previous file found missing, will be written to DOM log files 842. CDT 840 then continues walking directory structure of ASOT 830 looking for additional changes.

DOM 820 takes the path from CDT 840 for any new file that is found, reads the extension to determine the file type, and calls an extraction tool 850, 852 for that file type. In this embodiment, .docx and .pdf files are handled, which covers the vast majority of relevant files. However, data may be extracted from any desired file type without deviating from the scope of the invention. Extraction tool 850, 852 then pulls the text from the file, creates a JSON structure that holds an array of security portion markings found along with the associated text, and passes this information back to DOM 820. This is the extracted data structure.

DOM 820 then passes the extracted data structure to a cleaning tool (CT) 860, which performs a series of NLP training data preprocessing actions on the extracted text and then passes a similar JSON structure with the cleaned text back to DOM 820. CT 860 does not change the classification data. The preprocessing actions may include, but are not limited to, replacing a date with <date>, replacing a number with <number>, removing non-text (e.g., carriage return, \n, \r, \t, etc.), removing extra space, changing upper case letters to lower case, expanding contractions, removing punctuation, removing Latinization, removing stop words, checking spelling, performing lemmatization, changing curly quotes to straight quotes, etc.

DOM 820 now performs a measurement function on the extracted data structure, where DOM 820 determines the number of (marking, text) tuples in the structure for each of the different classification levels, such as unclassified (U), confidential (C), secret(S), top secret (TS), etc. This measurement 4-tuple will be associated with the extracted document data. DOM 820 next creates a new record in a database 870 in a database container 872 for the newly found document, including the fingerprint, path/location, extracted data, cleaned data, and measure 4-tuple. It should be noted that the file fingerprint is used as the unique index for this record in some embodiments. When CDT 840 comes across a directory named “SCGs” in some embodiments, CDT 840 handles the files in the same manner as with other directories, but also takes some additional actions. Specifically, CDT 840 captures the SCG file name for later use.

When CDT 840 completes its scan of ASOT repository 830, DOM 820 writes a new list of the current file fingerprints found in ASOT 830 to a date stamped record in database 870. This record provides an index to the set of the most recent (current) data records to be used for NLP training. It should be noted that previous such records with their date stamp may be retained. This provides a provenance record of files and data available for NLP training at any time in the past. Similarly, when CDT 840 completes, DOM 820 writes a new date stamped record in database 870 capturing the file fingerprints and file names for the current SCGs in ASOT 810. This database record is used by centralized reporting web application for providing a drop-down list of the current SCGs available in some embodiments.

DOM 820 now writes a CSV file with the current set of extracted training data in the 4-element row format (class level, compartment, dissemination, paragraphtext). DOM 820 then encrypts this file in some embodiments. If file size limitations are exceeded, multiple CSV files may be written in some embodiments. An unencrypted measurement file is now written that contains the counts for the number of different rows in the CSV file that are marked at the different classification levels, etc. At this point, DOM 820 terminates.

When DOM 820 is manually executed, it may function as a single pass scan and extract tool for ASOT 830. Ideally, this activity should be automated, with no human needed to refresh the training data by running DOM 820. This would ensure that system 800 can use and learn from new classification information as soon as the government receives these new documents. To make it an automatic and periodic process, DOM 820 can be set up as a cronjob 880 to run on an appropriate schedule, such as nightly or weekly.

### Training Data Balancing

The AI community identifies several reasons for balancing training datasets for deep learning. Balancing helps prevent bias towards the majority class, improves generalization and performance on unseen data, reduces the risk of overfitting, and enhances the interpretability of the model. To illustrate the importance of balancing the training dataset, consider the task of classifying images of chickens and raccoons. If the dataset contains 80% chicken images and only 20% raccoon images, an imbalanced training dataset may cause the model to classify most images as chickens, regardless of their actual content. However, by balancing the dataset, the model learns to distinguish between the two classes based on their distinctive features, resulting in more accurate and reliable predictions.

A quick turn function is used in some embodiments to generate synthetic data quickly. To be in family with the real-world training data, the synthetic training data should include to be realistic sentences. A fast way to generate realistic sentences is by leveraging a pretrained large language model (LLM) and feeding the LLM prompts of important keywords to create sentences that would trigger classification guidelines.

A training data balancer function may be employed that takes in the current population count of the classes and a list of keyword combinations for each class. The training data balancer function creates synthetic sentences using the provided keyword combinations to balance the classes. The count of the majority class determines the number of synthetic sentences to generate.

$$FinalClassCount = max [ ClassPopulations ]$$

It is typically desirable for all classes to have approximately the same number of samples as the majority class. The number of synthetic sentences to generate for each class is determined by the difference between its population count and the population count of the majority class.

$$NumToGenerate = FinalClassCount - ClassPopulation$$

For each sentence to be generated for a given class, a keyword combination is randomly sampled from the list pertaining to that class. The selected keywords are then given to a sentence generator. The sentence generator takes the keywords and places them into a pre-constructed prompt. The prompt is then fed into a REST API (e.g., REST API 132 of FIG. 1) that calls the LLM (e.g., MS Phi-3 Instruct). The LLM returns a generated sentence that contains the keywords in a context. The generated sentences are placed into a list that is returned from the balancer function.

The training data balancer requires two input files to build synthetic data in some embodiments. For instance, one file may include measurements of the current population count of classes (e.g., from the DOM) for security markings for level, compartments, and dissemination separately. Another file may include keywords or rules that, when used together in a sentence, will produce a classification within one or more of the minority classes. The file of keywords may be meticulously developed using SCG tables that identify specific keywords. When these keywords are used together in a context, the sentence is deemed to be classified. SCGs have many pages of tables that may be reviewed manually by a human to generate this file of key words. However, it should be noted that in some embodiments, the manual review process can be automated via a script and a Jenkins job workflow, for example, for example, which is an open-source automation server.

### NLP Operations

NLP operations pipelines are employed in some embodiments that, once triggered, automate the process for tuning, testing, and storing of the NLP model in preparation for loading a newly tuned model into the REST API for predicting security marking text. This automation pipeline may be created using Jenkins, for example. A Jenkins job may be created for the NLP retraining process that executes a set number of tasks to complete the workflow.

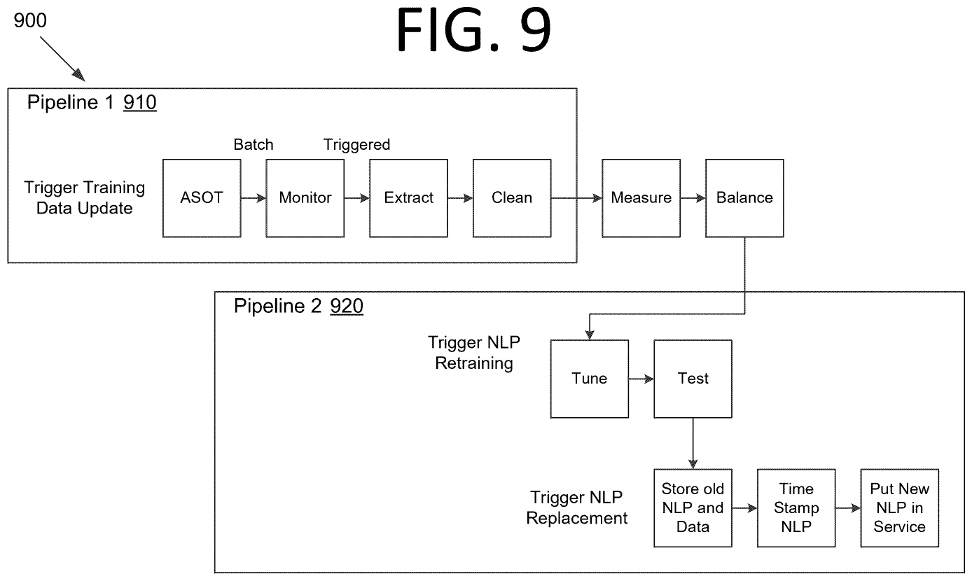

FIG. 9 illustrates data and NLP pipeline functions 900, according to an embodiment of the present invention. The steps of pipeline 1 910 correspond with those discussed above with respect to the DOM, as well as measuring and balancing. The NLP operations steps are included in pipeline 2 920. These abstract steps are tokenized into five steps for executed as a Jenkins workflow in some embodiments. The following are the Jenkins workflow set that can be found within the Jenkins configuration file (Jenkinsfile) in some embodiments
(1) Checkout Source Control Management (SCM): Checkout the model training source code from a Bitbucket source control.
(2) Generate NLP Model—Level: Train a model that predicts the level section of the classification marking.
(3) Generate NLP Model—Compartment: Train a model that predicts the compartment section of the classification marking.
(4) Generate NLP Model—Dissemination: Train a model that predicts the dissemination section of the classification marking.
(5) Save NLP Model: Move NLP model to an output folder for long-term storage.

Each time the government issues a demand signal for a new NLP predictor, the environment should contain the new NLP training data and a baseline pre-trained NLP model. Retaining previous NLP model accuracy measurement scores to compare to new accuracy measurement scores is not mandatory, but can assist with preparing trends. The following steps are a description of what is accomplished in some embodiments.
(1) Add Pretrained Models and Data: Add pretrained model, training data, and test data to the workspace. This step may be performed manually to exclude the large model and sensitive training data from source control.
(2) Install Dependencies: Install required dependencies.

The “Generate NLP Model” step in the Jenkins file performed retraining of the NLP model, which includes both the Tune and Test sequences. Note that retraining means tuning in this case. In some embodiments a Bidirectional Encoder Representations from Transformers (BERT)-based uncased model is used, which is an off-the-shelf open source NLP model that is pretrained on English language using a masked language modeling (MLM) objective. This version of BERT is not case-sensitive and does not distinguish between cases in words like “english” and “English.” However, any desired NLP model may be used without deviating from the scope of the invention.

In some embodiments, pretraining is completed in a self-supervised fashion. In other words, the model may be pretrained on raw text only with no human labeling. This allows the use of a large amount of publicly available data. The two objectives for the pretraining are:
(1) MLM: This means taking a sentence, masking 15% of the words in the input (or another percentage), and then running the entire masked sentence through the model to predict the masked words in some embodiments.
(2) Next sentence prediction (NSP): The model concatenates two masked sentences as input during pretraining. The model then must predict whether the two sentences follow each other.

This allows the model to learn an inner representation of the English language that can then be used to extract features useful for downstream tasks. There are two sizes of the BERT uncased models: base and large. The base sized BERT model may be selected in some embodiments to adjust for otherwise long run times (i.e., more than a day) and size constraints of the graphical processing unit (GPU), if an issue. To get the features of a given training data set, the off-the-shelf tuning can be performed using PyTorch or TensorFlow, for example. The PyTorch BERT implementation heuristic is provided below.
from transformers import AutoTokenizer, AutoModelForSequenceClassification
from torch.utils.data import DataLoader
tokenizer=AutoTokenizer.from_pretrained (“bert-base-uncased”)
model=AutoModelForSequenceClassification.from_pretrained (“bert-baseuncased”)
tokenized_input=tokenizer (dataset)
dataloader=DataLoader (tokenized_input, batch_size)
for batch in dataloader:
   output=model (**batch)

The pre-trained BERT model may be fine-tuned using data extracted and cleaned from NLP data operations pipeline 920. For efficiency, pretraining may be accomplished on GPUs. Due to the complexity of running the tune-test steps, scripts may be used to automate the process.

The “nlp_classifier/src/models/transformer_classifier.py” may be the main entry point for executing training and testing of the Bert-based uncased model in some embodiments. A shell script may be employed to handle setting up the Python environment and running the Python model training.

### Rest API

The REST API (e.g., REST API 132 of FIG. 1) is hosted by the REST server in some embodiments. The REST API creates a software interface between the NLP predictor model and external client application. A “predict_text_classification” endpoint may be used that accepts a JSON object containing a text string from the client request and returns a JSON response containing the model prediction of the security marking. Various endpoints are possible, including, but not limited to, the following:

GET/: This is default endpoint and returns a basic user interface created with “index.html”.

GET/health: This endpoint returns the state of the REST API service. It will fail to respond if the REST API is offline.

PUT/predict text classification: Per the above, this endpoint accepts a JSON object containing the text that will undergo classification prediction by the NLP predictor. It returns a JSON object that contains the original text and the predicted security classification label including security marking for level, compartment, and dissemination.

Separate NLP models may be used for each of the security markings for level, compartment, and dissemination in some embodiments. These NLP models are used to predict the security classification of the original text. The text is provided by an external application that makes a PUT request to the predict_text_classification endpoint. The resulting security classification label and confidence measure are returned to the REST API as a Python dictionary element, for example.

In some embodiments, classification validation is performed by a classification validator component of the REST API. This component determines whether a user-provided classification level, compartment, and dissemination is a valid combination. The script reads in a configuration file (e.g., in Yet Another Markup Language (YAML)) that defines a valid security marking level, compartment, and dissemination. A script may return a pair of result objects after the validate function is called, where one object provides details on whether the classification combination is valid and reasons for the validity and the other object attempts to return a valid classification combination with simple error correction. For example, in the case of a missing dissemination string, for S and higher classifications, the function may add a NOFORN dissemination.

As discussed above, various AI models may be used without deviating from the scope of the invention. For instance, these AI models may include, but are not limited to, NLP models, generative AI models, computer vision (CV) models, optical character recognition (OCR) models, etc. The AI models may be trained to achieve a desired confidence threshold while not being overfit to a given set of training data.

AI models may be trained for any suitable purpose without deviating from the scope of the invention, as will be discussed in more detail later herein. Two or more AI models may be chained in some embodiments (e.g., in series, in parallel, or a combination thereof) such that they collectively provide collaborative output(s). Any desired number and/or type(s) of AI models may be used without deviating from the scope of the invention.

Per the above, in some embodiments, generative AI models are used. Generative AI models can generate various types of content, such as text, imagery, audio, and synthetic data. Various types of generative AI models may be used, including, but not limited to, LLMs, generative adversarial networks (GANs), diffusion models, flow-based models, variational autoencoders (VAEs), transformers, etc. In the case of LLMs, for example, NLP models such as word2vec, BERT, GPT-3, ChatGPT, etc. may be used in some embodiments to facilitate semantic understanding and provide more accurate and human-like answers. For instance, the generative AI models may be trained on a large corpus of textual information to perform security classification marking tasks. In certain embodiments, generative AI models provided by an existing cloud ML service provider, such as OpenAI®, Google®, Amazon®, Microsoft®, IBM®, Nvidia®, Meta®, etc., may be employed and trained to provide such functionality, which may be requested via third-party APIs. Such embodiments may provide a more advanced and sophisticated user experience, as well as provide access to state-of-the-art NLP and other ML capabilities that these companies offer.

One aspect of generative AI models in some embodiments is the use of transfer learning. In transfer learning, a pretrained generative AI mode, such as an LLM, is fine-tuned on a specific task or domain. This allows the LLM to leverage the knowledge already learned during its initial training and adapt it to a specific application. In the case of LLMs, the pretraining phase involves training an LLM on a large corpus of text, typically consisting of billions of words. During this phase, the LLM learns the relationships between words and phrases, which enables the LLM to generate coherent and human-like responses to text-based inputs. The output of this pretraining phase is an LLM that has a high level of understanding of the underlying patterns in natural language.

In the fine-tuning phase, the pretrained LLM is adapted to a specific task or domain by training the LLM on a smaller dataset that is specific to the task. For instance, in some embodiments, the LLM may be trained to analyze a certain type or multiple types of data sources to improve its accuracy with respect to their content. This data may include, but is not limited to, prompt tuning or instruction tuning, where the model is specifically trained to better understand and follow certain types of instructions or prompts, improving its ability to perform specific tasks when given appropriate instructions. Such information may be provided as part of the training data, and the LLM may learn to focus on these areas and more accurately identify data elements therein. Fine-tuning allows the LLM to learn the nuances of the task or domain, such as the specific vocabulary and syntax used in that domain, without requiring as much data as would be necessary to train an LLM from scratch. By leveraging the knowledge learned in the pretraining phase, the fine-tuned LLM can achieve state-of-the-art performance on specific tasks with a relatively small amount of training data.

LLMs may use a vector database. Vector databases index, store, and provide access to structured or unstructured data (e.g., text, images, time series data, etc.) alongside the vector embeddings thereof. Data such as text may be tokenized, where single letters, words, or sequences of words are parsed from the text into tokens. These tokens are then “embedded” into vector embeddings, which are the numerical representations of this data. Vector databases enable LLMs to find and retrieve similar objects quickly and at scale in production environments, which is not possible via manual processes.

AI allows unstructured data to be numerically represented without losing the semantic meaning thereof in vector embeddings. A vector embedding is a long list of numbers, each describing a feature of the data object that the vector embedding represents. Similar objects are grouped together in the vector space. In other words, the more similar the objects are, the closer that the vector embeddings representing the objects will be to one another. Similar objects may be found using a vector search, similarity search, or semantic search. The distance between the vector embeddings may be calculated using various techniques including, but not limited to, squared Euclidean or L2-squared distance, Manhattan or L1 distance, cosine similarity, dot product, Hamming distance, etc. It may be beneficial to select the same metric that is used to train the AI/ML model.

Vector indexing may be used to organize vector embeddings so data can be retrieved efficiently. Calculating the distance between a vector embedding and all other vector embeddings in the vector database using the k-Nearest Neighbors (kNN) algorithm can be computationally expensive if there are a large number of data points since the required calculations increase linearly (O(n)) with the dimensionality and the number of data points. It is more efficient to find similar objects using an approximate nearest neighbor (ANN) approach. The distances between the vector embeddings are pre-calculated, and similar vectors are organized and stored close to one another (e.g., in clusters or a graph) similar objects can be found faster. This process is called “vector indexing.” ANN algorithms that may be used in some embodiments include, but are not limited to, clustering-based indexing, proximity graph-based indexing, tree-based indexing, hash-based indexing, compression-based indexing, etc.

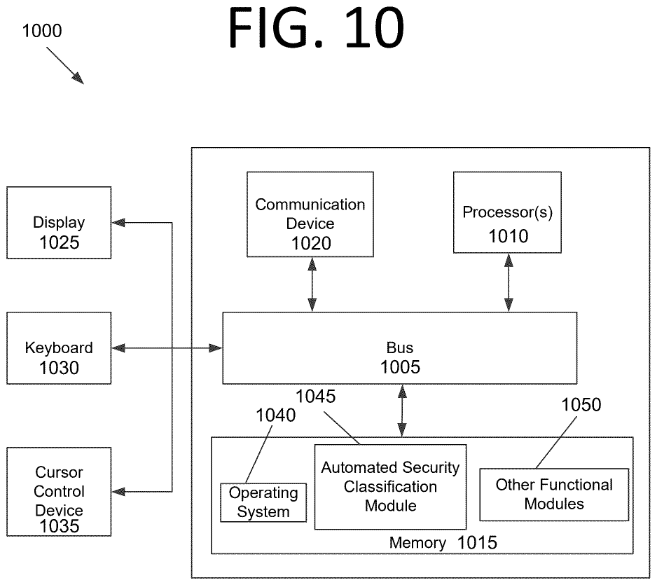

FIG. 10 is an architectural diagram illustrating a computing system configured to facilitate automated security classification of text and digital descriptive models using AI, according to an embodiment of the present invention. In some embodiments, computing system 1000 may be one or more of the computing systems depicted and/or described herein. Computing system 1000 includes a bus 1005 or other communication mechanism for communicating information, and processor(s) 1010 coupled to bus 1005 for processing information. Processor(s) 1010 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 1010 may also have multiple processing cores, and at least some of the cores may be configured to perform specific functions. Multi-parallel processing may be used in some embodiments. In certain embodiments, at least one of processor(s) 1010 may be a neuromorphic circuit that includes processing elements that mimic biological neurons. In some embodiments, neuromorphic circuits may not require the typical components of a Von Neumann computing architecture.

Computing system 1000 further includes a memory 1015 for storing information and instructions to be executed by processor(s) 1010. Memory 1015 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 1010 and may include volatile media, non-volatile media, or both. The media may also be removable, non-removable, or both. Computing system 1000 includes a communication device 1020, such as a transceiver, to provide access to a communications network via a wireless and/or wired connection. In some embodiments, communication device 1020 may include one or more antennas that are singular, arrayed, phased, switched, beamforming, beamsteering, a combination thereof, and/or any other antenna configuration without deviating from the scope of the invention.

Processor(s) 1010 are further coupled via bus 1005 to a display 1025. Any suitable display device and haptic I/O may be used without deviating from the scope of the invention. A keyboard 1030 and a cursor control device 1035, such as a computer mouse, a touchpad, etc., are further coupled to bus 1005 to enable a user to interface with computing system 1000. However, in certain embodiments, a physical keyboard and mouse may not be present, and the user may interact with the device solely through display 1025 and/or a touchpad (not shown). Any type and combination of input devices may be used as a matter of design choice. In certain embodiments, no physical input device and/or display is present. For instance, the user may interact with computing system 1000 remotely via another computing system in communication therewith, or computing system 1000 may operate autonomously.

Memory 1015 stores software modules that provide functionality when executed by processor(s) 1010. The modules include an operating system 1040 for computing system 1000. The modules further include an automated security classification module 1045 that is configured to perform all or part of the processes described herein or derivatives thereof. Computing system 1000 may include one or more additional functional modules 1050 that include additional functionality.

One skilled in the art will appreciate that a “computing system” could be embodied as a server, an embedded computing system, a personal computer, a console, a personal digital assistant (PDA), a mobile phone, a tablet computing device, a smart watch, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a LAN, a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

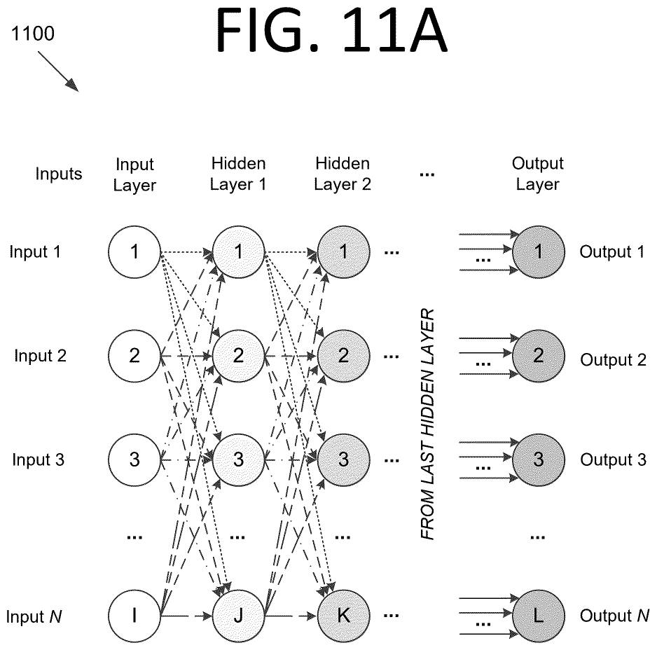

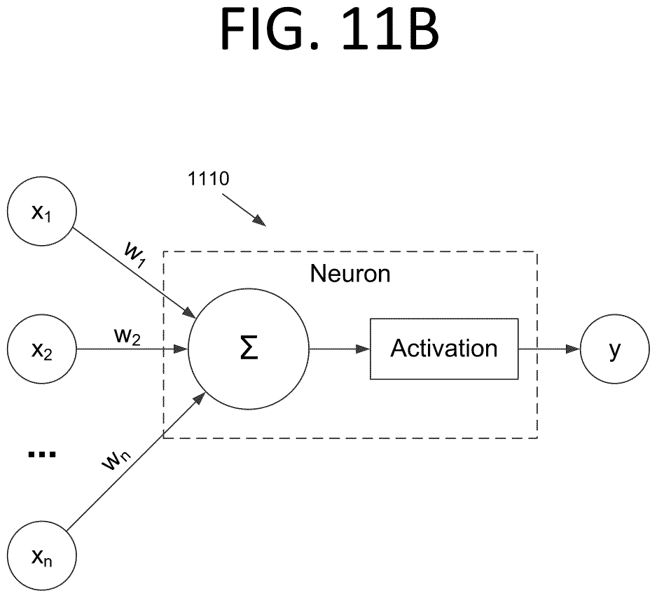

In some embodiments, neural networks or NLPs with neural network mechanisms may be used. Indeed, various types of AI/ML models may be trained and deployed without deviating from the scope of the invention. For instance, FIG. 11A illustrates an example of a neural network 1100 that has been trained to assist with automated security classification of text and digital descriptive models, according to an embodiment of the present invention. Neural network 1100 includes a number of hidden layers. Both deep learning neural networks (DLNNs) and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 1100.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

Returning to FIG. 11A, inputs are provided to input layer and then fed as inputs to the J neurons of hidden layer 1. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. While multiple suggestions are shown here as output, in some embodiments, only a single output suggestion is provided. In certain embodiments, the suggestions are ranked based on confidence scores.

It should be noted that numbers of neurons I, J, K, and L are not necessarily equal. Thus, any desired number of layers may be used for a given layer of neural network 1100 without deviating from the scope of the invention. Indeed, in certain embodiments, the types of neurons in a given layer may not all be the same.

Neural network 1100 is trained to assign confidence score(s) to appropriate outputs. In order to reduce predictions that are inaccurate, only those results with a confidence score that meets or exceeds a confidence threshold may be provided in some embodiments. For instance, if the confidence threshold is 80%, outputs with confidence scores exceeding this amount may be used and the rest may be ignored.

Neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative ∞ and positive ∞, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 1110 is shown in FIG. 11B. Inputs x₁, x₂, . . . , xₙ from a preceding layer are assigned respective weights w₁, w₂, . . . , wₙ. Thus, the collective input from preceding neuron 1 is w₁x₁. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function ƒ(x) to determine whether the neuron “fires”. For instance, ƒ(x) may be given by:

$$f ( x ) = \{ \begin{matrix}1 if \sum wx + bias \geq 0 \\ 0 if \sum wx + bias < 0\end{matrix} \qquad ( 2 )$$

The output y of neuron 1110 may thus be given by:

$$y = f ( x ) {\sum }_{i = 1}^{m} ( {w}_{i} {x}_{i} ) + bias \qquad ( 3 )$$

In this case, neuron 1110 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the invention.

A goal, or “reward function,” is often employed. A reward function explores intermediate transitions and steps with both short-term and long-term rewards to guide the search of a state space and attempt to achieve a goal (e.g., finding the most accurate answers to user inquiries based on associated metrics). During training, various labeled data is fed through neural network 1100. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the AI/ML model is not improving after a certain number of training iterations, a data scientist may modify the reward function, provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions ƒᵢ between each layer i=1, . . . , N of the network, with the output at a given layer first multiplied by a synaptic matrix Wᵢ, and with a bias vector bi added. The network output o, given by

$$o = {f}_{N} ( {W}_{N} {f}_{N - 1} ( {W}_{N - 1} {f}_{N - 2} ( … {f}_{1} ( {W}_{1} x + {b}_{1} ) … ) + {b}_{N - 1} ) + {b}_{N} ) \qquad ( 4 )$$

In some embodiments, o is compared with a target output t, resulting in an error

$$E = \frac{1}{2} {‖ 0 - t ‖}^{2} ,$$

which is desired to be minimized.

Optimization in the form of a gradient descent procedure may be used to minimize the error by modifying the synaptic weights Wᵢ for each layer. The gradient descent procedure requires the computation of the output o given an input x corresponding to a known target output t, and producing an error o−−t. This global error is then propagated backwards giving local errors for weight updates with computations similar to, but not exactly the same as, those used for forward propagation. In particular, the backpropagation step typically requires an activity function of the form pⱼ(nⱼ)=ƒ′ⱼ(nⱼ), where nⱼ is the network activity at layer j (i.e., nⱼ=Wⱼoⱼ₋₁+bⱼ) where oⱼ=ƒⱼ(nⱼ) and the apostrophe ' denotes the derivative of the activity function ƒ.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{new} = {W}_{j}^{old} - η \frac{\partial E}{\partial {W}_{j}} \qquad ( 8 )$$

$${b}_{j}^{new} = {b}_{j}^{old} - η \frac{\partial E}{\partial {b}_{j}} \qquad ( 9 )$$

where ∘ denotes a Hadamard product (i.e., the element-wise product of two vectors), T denotes the matrix transpose, and oⱼ denotes ƒⱼ(Wⱼoⱼ₋₁+bⱼ), with oₒ=x. Here, the learning rate η is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it performs well on the training data but does not perform well on other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. For example, one AI/ML model may be trained to recognize images, another may recognize text, yet another may recognize semantic and/or ontological associations, etc.

It should be noted that in addition to or in lieu of neural networks, some embodiments may use transformer networks such as SentenceTransformers™, which is a Python™ framework for state-of-the-art sentence, text, and image embeddings. Such transformer networks learn associations of words and phrases that have both high scores and low scores. This trains the AI/ML model to determine what is close to the input and what is not, respectively. Rather than just using pairs of words/phrases, transformer networks may use the field length and field type, as well.

NLP models such as word2vec, BERT, GPT-3, ChatGPT, other LLMs, etc. may be used in some embodiments to facilitate semantic understanding and provide more accurate and human-like answers, per the above. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the Density-Based Spatial Clustering of Applications with Noise (DBSCAN) clustering algorithm, the Gaussian mixture model (GMM) algorithms, the balance iterative reducing and clustering using hierarchies (BIRCH) algorithm, etc. Such techniques may also assist with categorization.

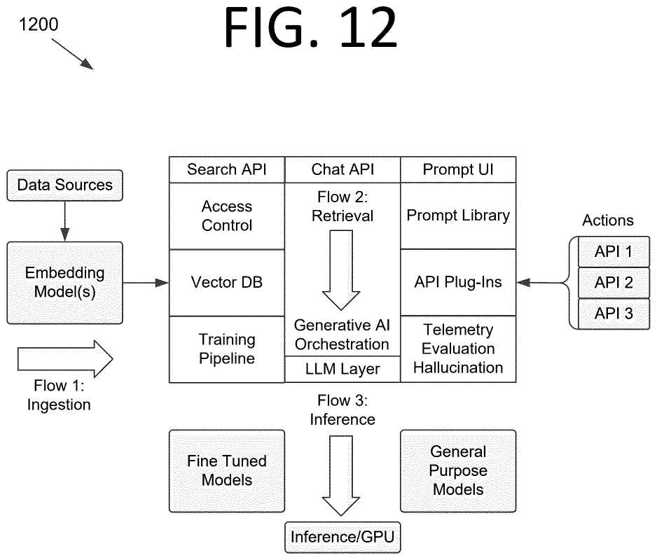

FIG. 12 is an architectural diagram illustrating a reference architecture 1200 for a generative AI model, according to an embodiment of the present invention. The architecture consists of several layers: API plug-ins, a prompt library, vector data source ingestion, access processing control, a model-training pipeline, an assessment layer to assess hallucination/telemetry/evaluations, a bring your own model (BYOM) embedding layer, and an LLM orchestration layer. There are also retrieval plug-ins, access control plug-ins, and API plug-ins that integrate into enterprise systems.

There are three main flows in this embodiment:

Data Ingestion and Training Flow: Data is read from multiple data stores, preprocessed, chunked, and trained through an embedding model (e.g., retrieval augmented generation (RAG)) and a training pipeline (i.e., fine-tuning). The vector database stores the chunked document embeddings that allow for better semantic, similarity-based data retrievals. As discussed above, these may come from SCGs.

Prompt Augmentation Using Data Retrieval: Once a user query arrives at the API layer, the prompt is selected, followed by data retrievals through the vector database or API plug-ins to get the right contextual data before the prompt is passed to the LLM layer.

LLM Inference: This is where there is a choice to use general purpose foundation models from or a self-hosted foundation model. Fine-tuned models may be used when tuned for a specific task or use case. The response is evaluated for accuracy and other metrics, including hallucinations.

It should be noted that in some embodiments, a generative AI model with multiple “heads” may be used. Heads refer to output layers of the generative AI model. Generative AI models typically have a sequence of layers, and each head will often share the first few layers of the model before diverging into their own distinct layers.

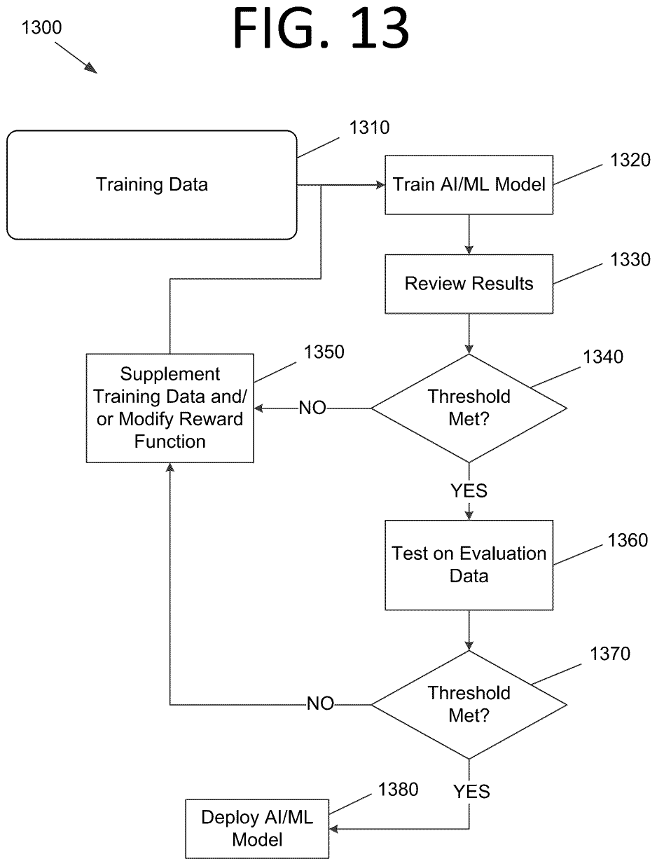

FIG. 13 is a flowchart illustrating a process 1300 for training AI model(s), according to an embodiment of the present invention. In some embodiments, the AI/ML model(s) may be generative AI models, per the above. The training process in some embodiments begins with providing training data, whether labeled or unlabeled (e.g., synthetic training data), at 1310. The training data may be of the types discussed above, for example. In the case of generative AI models, which are often generally trained, the training process may be skipped unless fine-tuned models are desired, which is often the case per the above. The AI model is then trained over multiple epochs at 1320 and results are reviewed at 1330. While various types of AI models may be used, LLMs and other generative AI models are typically trained (fine-tuned) using a process called “supervised learning”, which is also discussed above. Supervised learning involves providing the model with a large dataset, which the model uses to learn the relationships between the inputs and outputs. During the training process, the model adjusts the weights and biases of the neurons in the neural network to minimize the difference between the predicted outputs and the actual outputs in the training dataset.

One aspect of the models in some embodiments is the use of transfer learning. For instance, transfer learning may take advantage of a pretrained model, such as ChatGPT, which is fine-tuned on a specific task or domain in step 1320. This allows the model to leverage the knowledge already learned from the pretraining phase and adapt it to a specific application via the training phase of step 1320.

The pretraining phase involves training the model on an initial set of training data that may be more general. During this phase, the model learns relationships in the data. In the fine-tuning phase (e.g., performed during step 1320 in addition to or in lieu of the initial training phase in some embodiments if a pretrained model is used as the initial basis for the final model), the pretrained model is adapted to a specific task or domain by training the model on a smaller dataset that is specific to the task. For instance, in some embodiments, the model may be focused on certain types(s) of data sources. This may help the model to more accurately identify data elements therein than a generative AI model that is pretrained alone. Fine-tuning allows the model to learn the nuances of the source, such as the specific vocabulary and syntax, certain graphical characteristics, certain data formats, etc., without requiring as much data as would be necessary to train the model from scratch. By leveraging the knowledge learned in the pretraining phase, the fine-tuned model can achieve state-of-the-art performance on specific tasks with relatively little additional training data.

If the AI model fails to meet a desired confidence threshold at 1340 in some embodiments, the training data is supplemented and/or the reward function is modified to help the AI model achieve its objectives better at 1350 and the process returns to step 1320. If the AI model meets the confidence threshold at 1340, the AI model is tested on evaluation data at 1360 to ensure that the AI model generalizes well and that the AI model is not over fit with respect to the training data. The evaluation data includes information that the AI model has not processed before. If the confidence threshold is met at 1370 for the evaluation data, the AI model is deployed at 1380. If not, the process returns to step 1350 and the AI model is trained further.

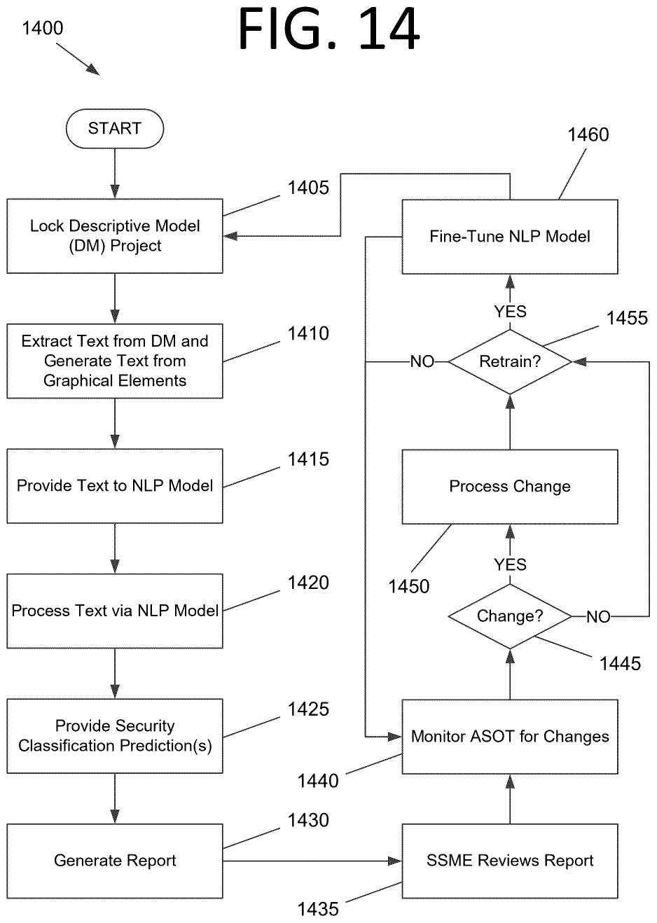

FIG. 14 is a flowchart illustrating a process 1400 for performing automated security classification, according to an embodiment of the present invention. The process begins with locking a project for a descriptive model at 1405 to provide access privileges to make changes to the descriptive model to add portion and banner markings. Text is extracted from the descriptive model and text is generated from graphical elements of the descriptive model at 1410. There is “text” inside the descriptive model in the form of property text, names, etc. Also, the descriptive model has graphics that represent information. This is where the unmodeling process that was discussed above comes into play. Rules are generated in order to generate sentences from the graphical notation and property text to provide the enriched context of the entire descriptive model.

The extracted and generated text is provided to an NLP model that has been trained and fine-tuned to take the extracted and generated text as input and automatically provide one or more security classification predictions for the descriptive model as output at 1415. In some embodiments, the extracted and generated text is provided to the NLP model via a REST API that is configured to wait for incoming text from a modeling tool that generates the descriptive model. In certain embodiments, the NLP model is a BERT-based uncased model.

The extracted and generated text is processed via the NLP model at 1420, and the NLP model provides security classification prediction(s) as output at 1425. In some embodiments, the security classification prediction(s) are for at least one of an entire model project for the descriptive model, one or more model views and/or diagrams of the descriptive model, one or more selected model graphical relationships between model elements, and one or more selected descriptive model elements. A report including the security classification prediction(s) is then generated at 1430 and reviewed by an SSME at 1435. In some embodiments, the report also includes the text sent to the NLP model, and the report is accessible via a centralized reporting web application for review.

In some embodiments, a modeling tool plugin for a modeling tool is configured to allow a modeler to invoke the automatic classification functionality for the descriptive model. In certain embodiments, the modeling tool plugin is configured to apply rules form an unmodeling process for generating natural language descriptions as the generated text from the graphical elements of the descriptive model. In some embodiments, the modeling tool plugin includes a security marking predictor, a settings GUI that provides configuration settings for operating the security marking predictor, and an import utility that allows the modeler to apply corrections reported by a quality check from a human-in-the-loop review.

A DOM monitors an ASOT for changes using a CDT at 1440. Responsive to the CDT detecting a change at 1445 based on ASOT state information and DOM log files, the change is processed at 1450. In some embodiments, this includes creating a unique fingerprint for a file that includes the detected change, passing the fingerprint and a path for the file to the DOM, calling an extraction tool for a type of the file, receiving an extracted data structure from the extraction tool, passing the extracted data structure to a CT, receiving a cleaned data structure from the CT, performing a measurement function on the cleaned data structure to generate a tuple, and creating a record in a database including the fingerprint, the path of the file, the extracted data structure, the cleaned data structure, and the tuple.

If it is time to retrain the NLP model at 1455 (e.g., due to a time period elapsing, due to a manual request, due to a certain amount of training data being received, etc.), fine-tuning of the NLP model is performed at 1460. This fine-tuning may be performed via one or more NLP operations pipelines using portion-marked text from a training database that includes properly security-marked documents and SCGs as an ASOT. In certain embodiments, the fine-tuning includes generating synthetic training data by providing an LLM with prompts that include keywords to automatically create sentences that trigger classification guidelines. In certain embodiments, the fine-tuning includes utilizing a training data balancer function that takes in a current population count of classes and a list of keyword combinations for each class and creates synthetic sentences using the provided keyword combinations to balance the classes.

The process steps performed in FIGS. 13 and 14 may be performed by a computer program, encoding instructions for the processor(s) to perform at least part of the process(es) described in FIGS. 13 and 14, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 1010 of computing system 1000 of FIG. 10) to implement all or part of the process steps described in FIGS. 13 and 14, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. One or more non-transitory computer-readable media storing one or more computer programs, the one or more computer programs configured to cause at least one processor to:
extract text from a descriptive model coded inside a modeling tool and generate natural language text from graphical elements of the descriptive model, the descriptive model comprising property text, names, and graphics representing information comprising information that comprises the property text and names;
provide the extracted and generated text to an artificial intelligence (AI) model that has been trained and fine-tuned to take the extracted and generated text as input and automatically provide one or more security classification predictions for the descriptive model as output, the fine-tuning comprising utilizing a training data balancer function that takes in a current population count of classes and a list of keyword combinations for each class and creates synthetic sentences using the provided keyword combinations to balance the classes;
process the extracted and generated text, via the AI model, and receive the one or more security classification predictions as output; and
generate a report comprising the one or more security classification predictions.

2. The one or more non-transitory computer-readable media of claim 1, wherein
the one or more computer programs comprise a modeling tool plugin for the modeling tool, and
the modeling tool plugin communicates with one or more external interfaces to allow a modeler to invoke the automatic classification functionality for the descriptive model.

3. The one or more non-transitory computer-readable media of claim 2, wherein the modeling tool plugin applies rules from an unmodeling process that creates a set of rules for automatically generating natural language descriptions as the generated text from the graphical elements of the descriptive model.

4. The one or more non-transitory computer-readable media of claim 2, wherein the modeling tool plugin comprises:
a security marking predictor;
a settings graphical user interface (GUI) that provides configuration settings for operating the security marking predictor; and
an import utility that applies corrections reported by a quality check from a human-in-the-loop review.

5. The one or more non-transitory computer-readable media of claim 1, wherein the extracted and generated text is provided to the AI model via a boundary Representational State Transfer (REST) Application Program Interface (API) that is configured to wait for incoming text from the modeling tool that generates the descriptive model.

6. The one or more non-transitory computer-readable media of claim 1, wherein the one or more security classification predictions comprise security marking predictions on at least one of an entire model project for the descriptive model, one or more model views and/or diagrams of the descriptive model, one or more selected model graphical relationships between model elements, and one or more selected descriptive model elements.

7. The one or more non-transitory computer-readable media of claim 1, wherein the one or more computer programs are further configured to cause the at least one processor to require that a project for the descriptive model be locked prior to providing the extracted and generated text to the AI model to provide access privileges to make changes to the descriptive model to add portion and banner markings.

8. The one or more non-transitory computer-readable media of claim 1, wherein
the generated report also comprises the text sent to the AI model, and
the report is accessible via a centralized reporting web application for review.

9. The one or more non-transitory computer-readable media of claim 1, wherein the one or more computer programs are further configured to cause the at least one processor to:
periodically fine-tune the AI model again via one or more AI operations pipelines using portion-marked text from a training database comprising properly security-marked documents and security classification guides (SCGs) as an authoritative source of truth (ASOT).

10. The one or more non-transitory computer-readable media of claim 9, wherein the one or more computer programs are further configured to cause the at least one processor to:
generate synthetic training data by providing a large language model (LLM) with prompts comprising keywords to automatically create sentences that trigger classification guidelines.

11. The one or more non-transitory computer-readable media of claim 9, wherein the one or more computer programs are further configured to cause the at least one processor to:
utilize the training data balancer function that takes in the current population count of classes and the list of keyword combinations for each class and creates synthetic sentences using the provided keyword combinations to balance the classes.

12. The one or more non-transitory computer-readable media of claim 1, wherein the one or more computer programs are further configured to cause the at least one processor to:
monitor an authoritative source of truth (ASOT) for changes using a change detection tool (CDT);
responsive to the CDT detecting a change based on ASOT state information and data operations manager (DOM) log files:
create a unique fingerprint for a file comprising the detected change, and
pass the fingerprint and a path for the file to the DOM, and
responsive to the DOM receiving the fingerprint and the path for the file:
call an extraction tool for a type of the file,
receive an extracted data structure from the extraction tool,
pass the extracted data structure to a cleaning tool (CT),
receive a cleaned data structure from the CT,
perform a measurement function on the cleaned data structure to generate a tuple, and
create a record in a database comprising the fingerprint, the path of the file, the extracted data structure, the cleaned data structure, and the tuple.

13. The one or more non-transitory computer-readable media of claim 1, wherein the AI model is a Bidirectional Encoder Representations from Transformers (BERT)-based uncased model.

14. A computer-implemented method, comprising:
extracting texting from a descriptive model coded inside a modeling tool and generating natural language text from graphical elements of the descriptive model, by a computing system, the descriptive model comprising property text, names, and graphics representing information comprising information that comprises the property text and names;
providing the extracted and generated text, by the computing system, to an artificial intelligence (AI) model that has been trained and fine-tuned to take the extracted and generated text as input and automatically provide one or more security classification predictions for the descriptive model as output, the fine-tuning comprising utilizing a training data balancer function that takes in a current population count of classes and a list of keyword combinations for each class and creates synthetic sentences using the provided keyword combinations to balance the classes;
processing the extracted and generated text, via the AI model, and receiving the one or more security classification predictions as output, by the computing system; and
generating a report comprising the one or more security classification predictions, by the computing system, wherein
the one or more security classification predictions comprise security marking predictions on at least one of an entire model project for the descriptive model, one or more model views and/or diagrams of the descriptive model, one or more selected model graphical relationships between model elements, and one or more selected descriptive model elements.

15. The computer-implemented method of claim 14, wherein
the computing system comprises a modeling tool plugin for the modeling tool,
the modeling tool plugin is configured to allow a modeler to invoke automatic classification functionality for the descriptive model, and
the modeling tool plugin applies rules from an unmodeling process that creates a set of rules for automatically generating natural language descriptions as the generated text from the graphical elements of the descriptive model.

16. The computer-implemented method of claim 15, wherein
the generated report also comprises the text sent to the AI model, and
the report is accessible via a centralized reporting web application for review.

17. The computer-implemented method of claim 15, further comprising:
monitoring an authoritative source of truth (ASOT) for changes using a change detection tool (CDT), by the computing system;
responsive to the CDT detecting a change based on ASOT state information and data operations manager (DOM) log files:
creating a unique fingerprint for a file comprising the detected change, by the computing system, and
passing the fingerprint and a path for the file to the DOM, by the computing system, and
responsive to the DOM receiving the fingerprint and the path for the file:
calling an extraction tool for a type of the file, by the computing system,
receiving an extracted data structure from the extraction tool, by the computing system,
passing the extracted data structure to a cleaning tool (CT), by the computing system,
receiving a cleaned data structure from the CT, by the computing system,
performing a measurement function on the cleaned data structure to generate a tuple, by the computing system, and
creating a record in a database comprising the fingerprint, the path of the file, the extracted data structure, the cleaned data structure, and the tuple, by the computing system.

18. One or more computing systems, comprising:
memory storing computer program instructions; and
at least one processor configured to execute the stored computer program instructions, wherein the computer program instructions are configured to cause at least one processor to:
extract text from a descriptive model coded inside a modeling tool and generate natural language text from graphical elements of the descriptive model, the descriptive model comprising property text, names, and graphics representing information comprising information that comprises the property text and names,
provide the extracted and generated text to an artificial intelligence (AI) model that has been trained and fine-tuned to take the extracted and generated text as input and automatically provide one or more security classification predictions for the descriptive model as output, the fine-tuning comprising utilizing a training data balancer function that takes in a current population count of classes and a list of keyword combinations for each class and creates synthetic sentences using the provided keyword combinations to balance the classes,
process the extracted and generated text, via the AI model, and receive the one or more security classification predictions as output, and
generate a report comprising the one or more security classification predictions, wherein
the generated report also comprises the text sent to the AI model, and
the report is accessible via a centralized reporting web application for review.

19. The one or more computing systems of claim 18, wherein the one or more security classification predictions comprise security marking predictions on at least one of an entire model project for the descriptive model, one or more model views and/or diagrams of the descriptive model, one or more selected model graphical relationships between model elements, and one or more selected descriptive model elements.

20. The one or more computing systems of claim 18, wherein the computer program instructions are further configured to cause the at least one processor to:
periodically fine-tune the AI model again via one or more AI operations pipelines using portion-marked text from a training database comprising properly security-marked documents and security classification guides (SCGs) as an authoritative source of truth (ASOT);
generate synthetic training data by providing a large language model (LLM) with prompts comprising keywords to automatically create sentences that trigger classification guidelines; and
utilize the training data balancer function that takes in the current population count of classes and the list of keyword combinations for each class and creates synthetic sentences using the provided keyword combinations to balance the classes.
